(19) United States
(12) Patent Application Publication
(10) Pub. No.: US 2014/0180792 A1
(43) Pub. Date: Jun. 26, 2014

(54) MOBILE COMMERCE BUSINESS SYSTEM AND METHOD FOR SHARING MERCHANT CONTENT AND CREATING A CUSTOMER INDEX

(71) Applicant: BARCLAYS BANK PLC, London (GB)

(72) Inventors: Safwan ZAHEER, Wilmington, DE (US); Stewart HOLMES, Wilmington, DE (US)

(73) Assignee: BARCLAYS BANK PLC, London (GB)

(21) Appl. No.: 13/725,061

(22) Filed: Dec. 21, 2012

(51) Int. Cl. G06Q 30/02

(52) U.S. Cl. CPC G06Q 30/0244
USPC 705/14.43; 705/14.45

(57) ABSTRACT

The present application is directed to mobile commerce systems and methods for allowing users to interact with and share merchant content, such as coupons or advertisements, and for creating a customer index based on tracked consumer activity with the merchant content. In particular, the application is directed to allowing users to interact with and share merchant content through a mobile wallet or mobile application, and to creating a customer index that allows merchants to identify and access those customers that actively engage with merchant content and that can influence the sale of a merchant's products or services.

### TECHNICAL FIELD

The present application is directed to mobile commerce systems and methods for allowing users to interact with and share merchant content, such as coupons or advertisements, and for creating a customer index based on tracked consumer activity with the merchant content. In particular, the application is directed to allowing users to interact with and share merchant content through a mobile wallet or mobile application, and to creating a customer index that allows merchants to identify and access those customers that actively engage with merchant content and that can influence the sale of a merchant's products or services.

### BACKGROUND OF THE INVENTION

The growth in the use of mobile devices, such as mobile phones, smartphones, PDAs and tablets, has led to consumers using these devices to search for, shop for, and buy products and services. Consumers want to use these devices to purchase products and services, and the development of web browsers run on mobile devices and mobile applications, such as mobile wallets, have allowed customers to browse for and then purchase goods and services using only their mobile device. Merchants realize that the mobile channel is becoming an important medium to engage consumers with their products and services, resulting in increased sales. Merchants attempting to attract consumers to their products often distribute various forms of merchant content, including advertisement, coupons, and special offers. Consumers can then redeem the merchant content at Point of Sale (POS) or online locations, thereby completing sales. However, merchants still use a “spray and pray” approach when it comes to delivering the merchant content to consumers on mobile devices. Consumers often do not engage or use the merchant content unless it is specifically relevant to their needs, and therefore the majority of merchant content distributed is not converted into money spent at merchant locations. Consumers also do not have access to options that make it easy, intuitive or fun to interact with the merchant content or share it with their network of family, friends, and peers.

Merchants recognize that closing the loop between the mobile device distributed merchant content and redemption of the content at POS locations is a key to realizing a return on their advertising and marketing investments. However, merchants do not have an effective way to target consumers through mobile devices who are likely to buy the products or services, much less a way to track and target consumers who are likely to both interact with the content and share the content with others, leading to increased sales of the products or services. Merchants do not have access to specific commerce related consumer data regarding interaction with and redemption of merchant content distributed through mobile devices. Therefore, merchants do not have a platform or tool to effectively promote products and services to consumers as well as increase the chances that merchant content is redeemed at POS locations.

What is needed is a system and method for allowing consumers to interact with and share merchant content distributed through mobile device channels, as well as a mechanism to track and analyze consumer behavior relating to the merchant content on mobile devices.

### SUMMARY

The present application is directed to mobile commerce systems and methods for allowing users to interact with and share merchant content using a mobile device, and for creating a customer index based on tracked consumer activity with the merchant content. The merchant content can come from either the merchant or the mobile publisher. Merchant content can come from the merchant portal or through a server/host computer connected to a cloud database. In a preferred embodiment, the consumer receives the merchant content within the mobile application. In another embodiment, a consumer can receive merchant content within a web browser or email on the mobile device and transfer it to the mobile application for tagging and sharing. The merchant content may be material or information desired by a merchant, such as, advertisements, loyalty, coupons, special offers, or any other digital content distributed by the merchant to the consumer over the mobile device. Customers interact with the merchant content through a user interface within a mobile wallet or in other embodiments, on other mobile applications running on a consumer's mobile device. The mobile wallet or application may be executed as computer readable instructions by a processor within the mobile device. The customer index may be incorporated into a platform that merchants can use to obtain information about particular customer interaction levels with the merchant content. Merchants may also use the platform to design marketing and advertising campaigns, and to promote specific products or services to particular consumers.

A customer may use the mobile application or mobile wallet or in another embodiment on other mobile applications running on a consumer's mobile device to tag, share and engage merchant content. The user interface within the mobile application is designed to provide selectable options to a consumer, making it natural and compelling for consumers to tag and engage merchant content. As part of engaging with the mobile content, the mobile application provides consumers with the option to share merchant content with their network of friends, family, and peers. This shared content can include any tags or other comments added by the consumer, or it may be the original merchant content without the consumer's added tags. By providing a mechanism for consumers to share the merchant content with others, the mobile application allows for merchants to reach a wider audience through direct influence by friends or family members. For example, if a consumer views particular merchant content, such as a coupon, the consumer will have the option to tag the content with a verb such as “love it,” “use it,” “view it,” or “buy it” Etc. The customer may choose to share the tagged content with others, and the mobile application allows the consumer to send the tagged content to other consumers for consumption. As part of sharing activity, the mobile application may provide consumers with the option to leave the content for other consumers to collect at merchant locations for redemption. The ability to perform this sharing activity will lead some consumers to engage more with merchant content than others.

A mobile publisher may track and identify consumer engagement propensities, allowing them to determine which consumers are power consumers and which consumers do not respond or share mobile content. A power consumer is a consumer who has a high level of interaction with the merchant content provided on the mobile device, and who has a greater propensity to share the merchant content with others. The interaction with and sharing of merchant content using the mobile application will drive greater redemption of products/services at merchant locations.

The mobile publisher is the entity that delivers a platform for merchants and consumers to consume/use/view/interact with, such as a mobile application or wallet. The mobile publisher is the entity that provides the system (e.g. mobile app/wallet) for both merchants and consumers to interact. The mobile publisher provides or builds the entire platform consisting of a cloud database, server/host computer that performs computing (analytics, segmentation, etc.), the mobile applications, as well as the merchant portal, the mobile publisher has access to track the activity of the consumers using the mobile wallet or application. In other words, the mobile publisher owns the data collected through the use of the mobile application. The data is stored in a cloud database, which the mobile publisher has access to, and the mobile publisher also performs the analytics that enables it to determine consumers' commerce behavior (e.g. a consumer's preferences, where he likes to shop, what products the consumer usually buys, when does he typically make the purchases, etc.).

As mentioned above, the publisher of the mobile application will be able to track consumer activity related to the merchant content provided. The mobile publisher may then calculate a consumer index corresponding to each consumer's activity with merchant content on the mobile device. The index not only incorporates consumer's activity, but also accounts for the effect that the sharing has on the call-to-action of content (for instance, redemption at merchant locations). The mobile publisher can then use the index for various purposes such as designing specific advertising or marketing campaigns, and/or promoting specific merchant content, products and/or services to consumers.

A self-serving mobile or online portal is provided that displays user specific data, such as the index, to enable merchants who access the portal to design campaigns for consumers. The portal may also contain a bidding platform so that merchants can place bids to request access to those consumers (for instance power users) that will influence sale of its products/services with other consumers. The online portal may be managed by the mobile publisher. The portal is hosted and managed on the web or mobile application and is managed by mobile publisher). A server connected to the cloud database allows the mobile publisher to host the portal. The portal is linked to the mobile application used by the consumers through the cloud.

Data from the mobile application can be transferred to the portal. For example, in one embodiment data from the merchant portal can be uploaded and stored on a server that retrieves customer data that is housed in the cloud database. Similarly data or content served in the mobile wallet or mobile application can be sent to and from a server that provides and receives customer data housed in the cloud database.

### BRIEF DESCRIPTION OF THE DRAWINGS

FIG. 1 illustrates an example of a user interface of a mobile application for interacting with and tagging merchant content.

FIG. 2A is an illustration of selecting a merchant location, selecting recipients for the merchant content, and sharing the merchant content according to one embodiment of the present application.

FIG. 2B is an illustration of sharing the merchant content using a “bump” feature in the mobile application according to one embodiment of the present application.

FIG. 3 is an illustration of a network identifying power users derived through tracking which users share merchant content with others. The figure represents the interactions to show the difference between inactive, power, and moderate users.

FIG. 4 is an illustration of the development of the customer index.

FIG. 5 is an illustration of a merchant platform and portal according to one embodiment of the present application.

### DETAILED DESCRIPTION

A system and method for allowing mobile device users to interact with and share merchant content through a mobile wallet or other mobile application run on a mobile device is disclosed. The system and method disclosed further allow publishers of the mobile application to track consumer activity with the merchant content, including how often consumers redeem offers within the content or share merchant content with others. The system and method further includes a mobile or web based portal that uses the tracked consumer activity to display a customer/consumer index that represents the level of consumer engagement (sharing, redeeming, clicking, posting, etc.) with content served in the mobile app/wallet. This customer index is displayed on the portal, which may be accessed by merchants who desire information regarding the consumer behaviors of customers receiving merchant content on mobile devices.

The mobile application (“app”) is stored on the mobile device memory. Consumers can download the app using the phones' app store e.g. iPhone app store or Android app store. The merchant inputs content/ campaigns on the merchant portal, which is connected to the cloud, which is in turn is tied to the mobile application/wallet on the device. Merchants access the portal through computers or mobile devices over the internet or other network that is, the merchant must have access to an internet connection to access the merchant portal. Consumers using a mobile device will be presented with merchant content hosted in the mobile device, such as in a mobile application or mobile wallet application.

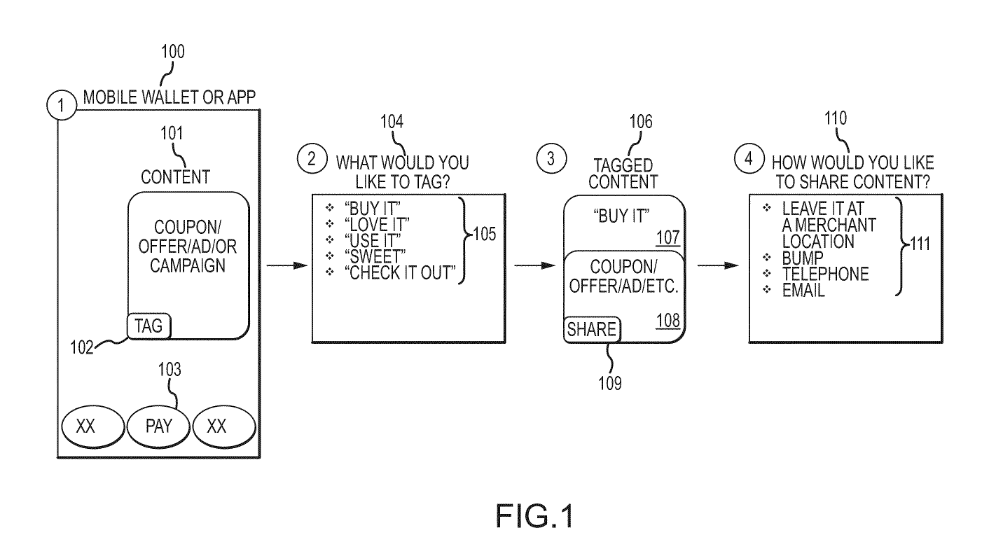

Merchant content can include any digital information that promotes or introduces merchant products or services and entices consumers to try or purchase the products or services. Merchant content can come from the merchant or the mobile publisher. Merchant content can come from the merchant portal or through a server/host computer connected to a cloud database. Merchant content may include coupons, offers, advertisements, merchant programs, loyalty programs, or campaigns. The content presented may have built-in interfaces providing consumers the option to tag content with selected terms. The merchant does not have to have the application on their end in order to provide the merchant content that the user can interact with as merchants can send campaigns/content through the merchant portal. The mobile publisher will take care of the formatting as it hosts and manages the system that provides the mobile app/wallet functionality. If the consumer sees merchant content with built-in interface to tag, the consumer does not need to download any other additional mobile applications for the tagging or sharing functions as the mobile content itself provide all options necessary to the user on the display screen. See FIG. 1. The consumer/user first downloads the mobile app from an app store (e.g. iOS and Google Play), registers the app, and then can start using the app at merchant locations. The content to be displayed to the consumer will automatically be updated by the mobile publisher.

As shown in FIG. 1, the merchant content may be displayed to a consumer on a mobile device through a mobile wallet, or mobile application 100. The merchant content 101 may include a selectable option 102 allowing the consumer to tag the content. The mobile wallet or application 100 may also provide the consumer with additional options 103 related to the displayed merchant content, such as the option to make a payment to obtain the product or service of the merchant content.

When a consumer presses the selectable option 102 on the interface of the merchant content 101, they are presented with an option 104 asking how they would like to tag the content. This option 104 presents the consumer with selected terms 105 to tag the content. The terms to tag the content may include, but are not limited to, “love it,” “use it,” “view it,” “sweet,” “buy it,” or “check it out” or others. The choice of terms that are presented to consumers are not random. Rather, the mobile publisher selectively chooses terms that contain at least one of two elements. One element incorporates the social and sharing aspect of the tagging activity, making it fun for consumers to share with friends, family, or peers. For example, this element could include terms like “buy it,” “use it,” ‘or “love it.” The other element prompts redemption of the associated content at merchant locations. For example, this element could include terms like “check it out,” which may be linked to a particular merchant location. Additionally, the mobile publisher has the ability to dynamically change the terms presented to each consumer based on merchant content or on consumers past activity with merchant content. The mobile publisher has the ability to set this on a per consumer basis. For example, the choice of terms presented to a first consumer using a mobile device displaying the merchant content may be completely different from those that are presented to a second consumer. The mobile publisher learns about the consumer behavior because it collects consumer data and processes it in a server containing specialized software that provides insights about consumer's commerce behavior. Additionally, the consumer using the device may have the option to select from pre-made lists of terms to choose favorite terms that are displayed as a default. The consumer may also be presented with the option to create their own terms to tag the merchant content. All of these options creates a user-friendly interface for the consumer as well as creates the ability for the mobile publisher to customize the interface based on the consumer's behavior.

After a consumer chooses a tag from the selected terms 105, the consumer is shown the tagged content 106, which now includes the merchant content 108 and the selected tag word 107. The consumer is prompted to share content with friends, family or peers via a share button 109 on the content. The combined tagged verb 107 and content 108 is presented inside the mobile application or wallet. The tagged interface is part of the mobile wallet or application and is displayed inside the applications. In an alternate embodiment, the tagged content interface could be part of a webpage that is opened through a browser on the mobile device.

Merchants can create specialized content/campaigns in the portal and mobile publishers will serve the content in the mobile app/wallet. In some embodiments the mobile publisher can also create merchant related content. The mobile publisher has control over the “tag” interface that is part of the merchant content. The tag interface is added by the mobile publisher within the application or wallet.

After pressing the share button 109, consumers will be presented with a selectable menu 110 on the interface. The selectable menu 110 provides the consumer with options 111 relating to the method by which they may share the merchant content with others. These options 111 may include “Leave it at Merchant Location,” “Bump,” “Email,” or “Telephone” or others. Some of these options are discussed in further detail below.

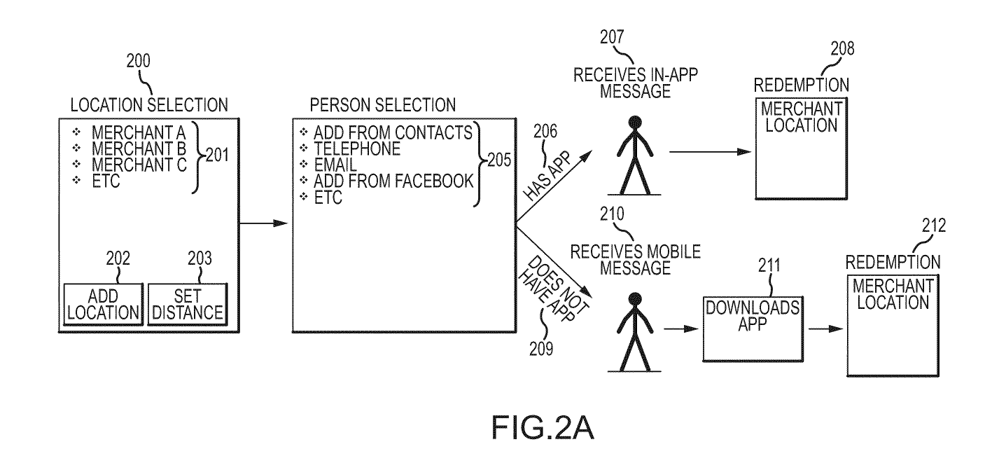

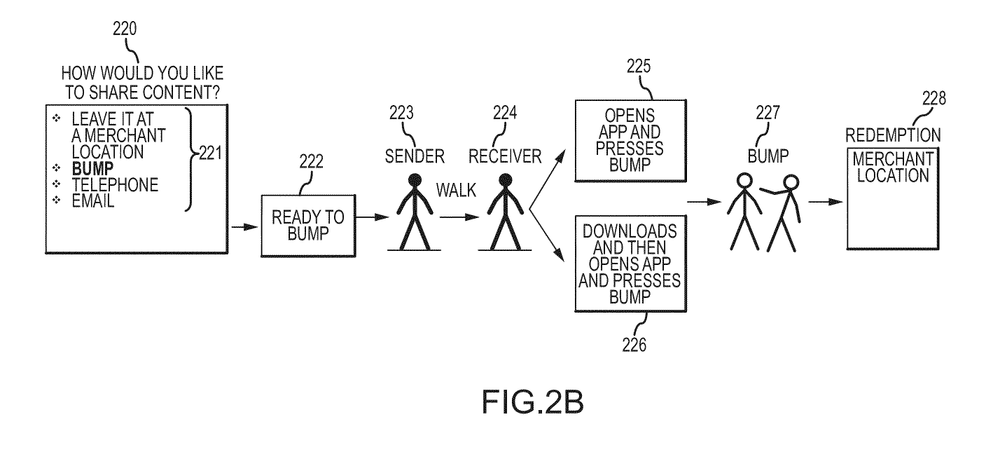

FIG. 2A illustrates the process for sharing when the consumer selects the “Leave it at Merchant Location” option. Upon selection of “Leave it at Merchant Location,” from the options 111 shown in FIG. 1, a new screen 200 appears on the user interface with a pre-populated list of merchants 201 that are within certain distance of the consumer's location. The consumer's location can be determined by any available methods, such Global Positioning System functionality within the mobile device, by publicly available or private Wi-Fi networks, or by communication with satellite networks or any other technology the mobile device is able to communicate with, which provides information regarding location. In the situation where a plurality of merchants are within the general area of the consumer's location, the mobile application or mobile wallet may not randomly populate the list with “all” merchants that are generally located within a certain distance of consumer's location. Instead, the mobile application or mobile wallet may only present those merchant locations that accept the mobile publisher's application or wallet for payment transactions, or those which have the capabilities to store the merchant content left by one consumer for redemption by others using the mobile application or mobile wallet. The consumer will also have the ability to set a merchant location 202 and increase/decrease the distance setting 203 in selecting a merchant location at which to leave the content.

After the consumer selects the merchant locations at which to leave the merchant content, the consumer is presented an interface 204 with various options 205 to select the person with whom the consumer wants to share the content. Consumers can either select the person from the contacts list stored in the mobile device, or they can manually add the email and/or telephone number of the person they would like to share the content with. In addition, consumers have the option to add a friend, family member, or peer through their social media accounts or any other social media or internet site such as Facebook, Twitter, Linkedin, Pinterest, etc. Additionally, the mobile publisher may add (or delete) new ways for consumers to select the person they want to send the content to. Since the mobile publisher develops the app it can make any changes in the software controlling the app/wallet to enable any new functionality or enhancements including adding any new ways for consumers to select the person to share; all of this will be seamless to consumers of the mobile app/wallet. In certain embodiments, it will be through updates to the mobile application.

Once the consumer selects the person, or persons, with whom the consumer wants to share the merchant content, a message is sent to those selected persons. If a selected person has the same mobile wallet or mobile application as the consumer, a message is sent 206 and received by the selected person within the mobile wallet or mobile application on that person's mobile device 207. The person receiving the content will be notified via a message 207 within the mobile application or wallet that they have received a content which is waiting for them to be redeemed at a particular merchant location. The message can also be a text/SMS or email that will identify the type of content as well as the merchant location to redeem content. The person can then visit the location, where the person can fulfill any conditions of the content to be able to redeem it instantaneously at the merchant location 208. In order to redeem the merchant content, the person may have to use the mobile application or wallet within the location, make a purchase for a particular amount, or buy a particular item. For example, if the content is a coupon for dollars off of a purchase, it will be applied as soon as the person uses the mobile application or wallet to make that purchase at the location. The mobile wallet can be used to make the purchase at the location. In general, the cashier rings the amount of the sale and a signal is sent to the cloud. The cloud generates a QR code of the payment and sends it to the payment terminal, the mobile user scans a QR code (representing the transaction amount) and the signal is sent back to the cloud. The cloud (which holds consumer credit card data) then sends a signal to a payment gateway for authorization. Once authorized, the cloud sends a confirm authorization signal to the consumer, which authorizes the amount, and the cashier receives a confirmed signal.

In an event where the person receiving the content does not have the mobile application or wallet to redeem content 209, the person may be sent a message 210 through a text/SMS, email or other electronic message on their mobile device to download the mobile application or wallet. For example, these consumers may receive a general text/SMS or email notifying them of content a friend “left at a merchant location” along with instructions and a selectable option 211 to download the mobile application or wallet to their mobile device. The person selects the option and downloads the mobile application or wallet 211, the person may redeem the merchant content at a merchant location 212 as described above.

FIG. 2B illustrates the process to share and redeem content when a consumer selects the “bump” option 221 to share content from a selectable list of options 220 for sharing content. Upon selection of the “bump” option, a screen notifying the consumer that it is ready to bump content 222 appears on the user interface. This is a notification to the consumer that it is ready to transfer (or bump) the content to another person. The consumer, who is now a sender 223, then goes to the recipient 224 so that the two can place their mobile devices in proximity to each other. The recipient opens a mobile application or wallet within his own mobile device, and presses a ‘bump’ selectable option 225 on the wallet to receive the content. The content the sender is sharing with the receiver is already in the cloud and once the receiver is ready to receive content (signaled by pressing the bump button and physically bumping the two phones) content from the cloud is sent directly to the recipient. If the recipient does not have the mobile application or wallet installed on their mobile device, they first download the mobile wallet application or wallet 226 and then press the bump selectable option 225. The two then physically bump the mobile phones together with the recipient to accept the content. In other embodiments, the sender and recipient do not need to physically “bump” phones in order to transfer the merchant content. Instead, the transfer can occur through any communication means when the devices are in proximity to each other. These transfer means can include wired or wireless communication transfers, Near Field Communication, Bluetooth, or infrared.

When consumers select the ‘Telephone’ or ‘Email’ option from the list of options 111 shown in FIG. 1, they may be prompted to input the intended recipient's telephone or email information. Consumers can either use the mobile phone's contact list to add the person's telephone/email, or may manually enter the information. Once the contact information is entered, the receiving person receives a text/SMS, email, or other electronic message within the mobile application or wallet on that person's mobile device. This text/SMS, email or other message notifies the recipient that they have received merchant content from another consumer that may be of interest to the recipient. In an event where the person receiving the content does not have the mobile application or wallet necessary to redeem content, the text/SMS, email or other message may contain instructions and a selectable option to download the mobile application or wallet.

As consumers use the mobile application or wallet to interact with and tag merchant content and to share this content with others, the mobile publisher collects, stores, and analyzes consumer data related to the use of merchant content to determine insights about consumers commerce behavior, such as where consumers like to buy, how much do they typically spend on goods, what time of day consumers like to spend, where do they most frequently buy or purchase products, etc. Data that is collected from the consumers' activity with merchant content may include type of content shared, type of tags used with content, and frequency with which the consumer shares content with other consumers in their network, etc. All of the consumer activity related data that is tracked, stored, and analyzed may be stored in a cloud database that is owned by the mobile publisher. The cloud is connected to the payment terminal of merchant locations with which the mobile application on the device interacts to initiate and confirm payment transactions via QR codes. The cloud is part of the mobile wallet system that is managed by the mobile publisher and hence it has access to all consumer related data such as credit cards stored, number of transactions, size of transactions, location, time of the day, type of content consumer redeems, etc. The information is primarily stored on a cloud database, or could be in a host server or computer that has access to the cloud and can pull specific pieces of consumer data. The mobile publisher may use this information on consumer activity to segment and identify consumers that are active in using and engaging with merchant content versus those that are not as active. The mobile publisher can then use the information collected and analyzed to the benefit of both consumers and the merchants by serving relevant content that meets consumer's needs and providing incentives to those consumers, identified as active, who can influence sale of merchant product/services.

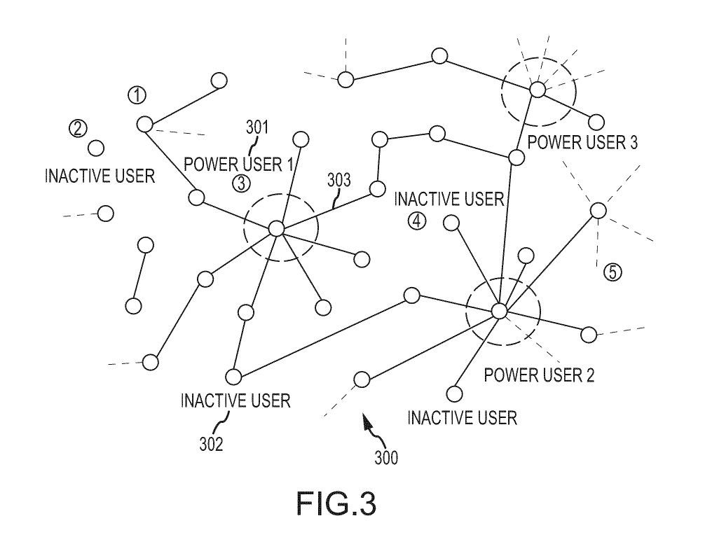

FIG. 3 illustrates a network of users 300 interacting with the merchant content on mobile devices, and shows the sharing activity 303 between users. As shown in FIG. 3, power users 301 are identified as those users who engage with merchant content and who shared merchant content with a plurality of other users. Inactive users 302 are identified as those who do not engage with merchant content or who are not motivated to share any information with others. The mobile publisher may track the behavior of those using the mobile wallet, application or device to interact with the merchant content. The mobile publisher may also store information relating to this behavior in a database for further analysis and processing. The information may be used by the mobile publisher for the mutual benefit of consumers and merchants. For example, the mobile publisher may want to drop inactive consumers to grow the overall commerce activity between consumers and merchants through the mobile application and wallet. For example, a mobile publisher can stop serving the inactive consumers merchant content to the point that these inactive users may not see a need to use the mobile app/wallet anymore and decide to abandon it. Additionally, the publisher may use approaches such as providing special coupons/offers or discounts as merchant content within the mobile application or wallet to convert the inactive behavior of consumers to active behavior.

Some consumers may only moderately engage with merchant content. The mobile publisher may track and store activity of such users. The mobile publisher can try to vary delivery of merchant content to convert the relatively inactive behavior of these consumers to active behavior. The mobile publisher may use approaches such as providing special coupons/offers or discounts as merchant content within the mobile application or wallet to entice moderate consumers to increase their engagement with the merchant content.

Those users identified as power users are the consumers within the network who actively engage with and share the merchant content. The mobile publisher may use the information collected on user activity to identify and place special emphasis on these users because they are instrumental in driving sale and awareness of merchant products and services. The mobile publisher may track the type of merchant content the power consumers share, including the tags used. It may also track the frequency with which the content is shared, and with whom it is shared. The mobile publisher may also use the information to understand why a consumer uses some merchant content but not others. For example, if a consumer interacts more with content served from a coffee shop/merchant, the mobile publisher can continue to push similar content (coffee, offers in a cafe/coffee shop, caffeine related promotions, etc.) to this user so the consumer continuously uses the mobile application/wallet to make transactions at coffee related merchants. Without knowing this particular behavior of consumer (for example, a coffee lover) and appropriately targeting the right content; the consumer would not have received relevant content serving its need as well as providing value at the same (e.g. a discount), and as a result the merchant serving the content may have lost the transaction to a competitor since the coffee lover may have gone to a competitor to purchase coffee. The mobile publisher may share these findings with merchants so they can use it to enhance their products or services and to deliver relevant content to consumers.

The mobile publisher may use the collected consumer information to create a customer/consumer index, which is a unique qualitative level assigned to each consumer representing the level of their engagement with merchant content using the mobile wallet or application. It represents the effect a particular consumer has in contributing to the redemption of merchant content served in the mobile application/wallet. The calculations to create the index are performed at a host computer managed by the mobile publisher. The mobile publisher processes the stored consumer information to calculate the commerce index. The processing automatically picks power users of the mobile application or wallet and assigns them premium status within the network.

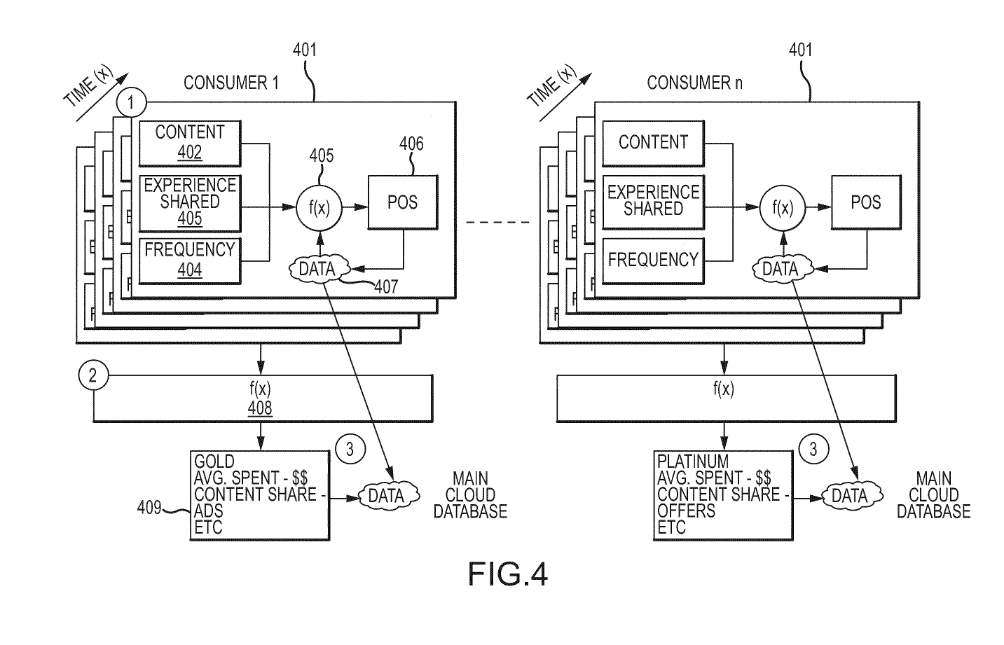

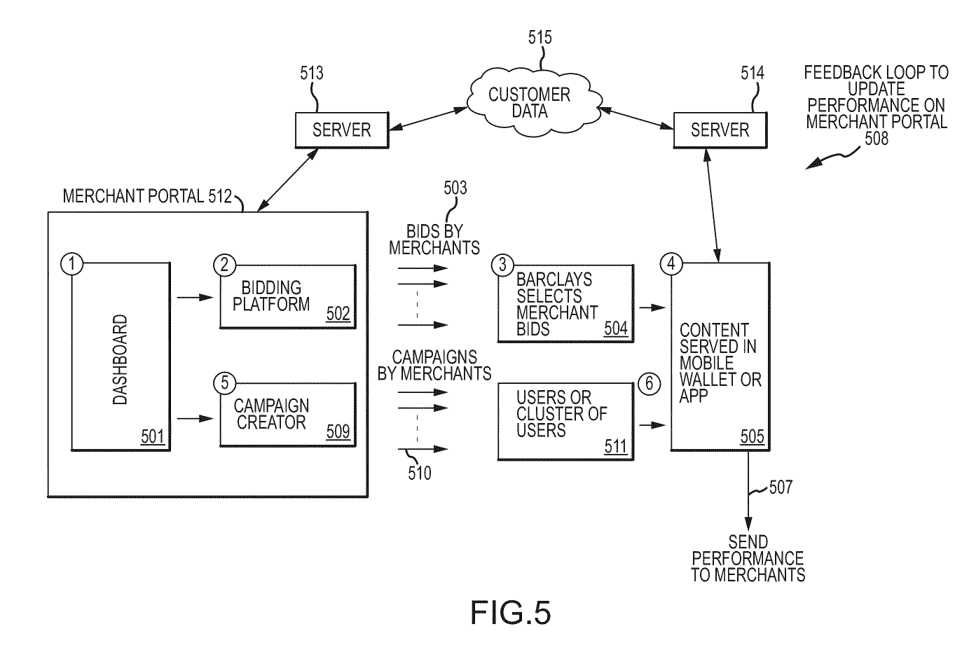

The processing may be carried out at a host computer using a computer processor executing instructions stored on a computer readable medium. The processor may be in communication with the information database storing the consumer activity information. As shown in FIG. 4, the instructions may cause the processor to initiate and collect consumer data each time the consumer is presented with merchant content 401. In certain embodiments, the host computer may store at least three pieces of information before further processing of the stored consumer activity information. These include the type of content the consumer clicked or used 402, the experience the consumer tagged with the content 403, and the number of times the consumer shared the content with other consumers in its network 404. The processor then executes instructions 405 to quantify the three pieces of information into a numerical level. In quantifying the three pieces of information, the processing may combine other pieces of consumer data stored in the database of consumer activity information (515, FIG. 5). This other consumer data may include credit card usage data, typical size of transactions, dollars spent at locations, or the number of times a consumer visits a particular merchant. The decision to combine other pieces of data stored in database may depend on whether a particular consumer is a power user, an inactive user, or a moderate user when it comes to using and engaging with merchant content within the mobile device.

The host computer then tracks whether the combined information of content, experience shared, frequency, (and any other piece of data) is redeemed at merchant locations 406 (point of sale (POS)). The resulting tracking data is used in further processing to determine the qualitative level assigned to the consumer (performed in 407). If the combination results in redemption or sale of products/service at merchant locations, a stronger value is assigned to that combination, and the host computer records the consumer who initiated sharing of merchant content. For example, a level of ‘1’ may be assigned every time a particular combination of content and experience is redeemed and a level of ‘0’ may be assigned when it is not redeemed. The resulting information and the location of merchant store will be stored in the database 407, which communicates directly with the cloud database that holds consumer data related to the use of mobile wallet or application (410) (or 515, FIG. 5).

The above description is a snapshot of one consumer engaging with merchant content at one instance of time. The processing may be repeated for each consumer of the mobile application or wallet every time the consumer is presented with merchant content, thus forming an iterative process of continuously updating scores that change over time.

Every time a piece of content is served to consumers and a score calculated, it will be combined with scores from previous iterations for normalization as shown in 408. For example, if in 10 instances of times 8 of the instances resulted in redemption and 2 did not, the resulting score will be 8. Similarly all instances of content, experience shared, and frequency of share will be stored and an average corresponding to each piece of information may be calculated and stored. If a consumer continuously shares ads of merchant products or services, the corresponding average stored, at that instance of time, will be ‘ads’ for that consumer—indicating a preference for ads as a content for that particular user.

The customer index may be a qualitative level that places consumers in certain categories 409 representing their influence in driving purchase of merchant products/services. These qualitative levels may be stored in a database 410 or 515. The categories and levels of these consumers may be set by the mobile publisher. For example, the mobile publisher may set three levels using level designations such as platinum, gold, or silver—to represent three categories of consumers that have the potential to influence sale of merchant products/services. Platinum consumers may be those that have the highest score as described above and that fall within a range set by the mobile publisher. The ranges will change dynamically according to the use of mobile wallet or application for commerce activity.

As shown in FIG. 5, the customer index will be displayed in the mobile commerce dashboard 501, hosted by the host computer as a web or mobile application portal. The customer information included in the dashboard may include data such as average dollars spent, average content shared and average number of times consumers share content with others in the network, etc. The mobile commerce dashboard may continuously be updated as consumers use the mobile wallet or application over time. As part of analyzing consumer's commerce activity, the mobile publisher may provide a merchant platform or portal 512 for use by merchants. The portal can either be supported on a mobile and/or online channel. The portal may contain a dashboard 501 that will display data corresponding to each user or cluster of user's use of the mobile wallet, thereby providing a snap shot of each consumer's commerce behavior at a particular instance of time. A cluster of users is set of consumers that share a similar commerce behavior, e.g. apparel lovers, coffee lovers, sports fanatics, etc. Elements of data that may be displayed may include the customer index, average dollars spent, type of content most engaged, tags used, and average frequency of content shared.

The portal may include a bidding platform 502 that merchants can use to request access to those users that can influence sale of merchant products/services. For example, merchants may be interested in accessing Platinum users of the network to influence sale of their products/services within the Platinum users' network. Merchants may request access 503 to users through methods set by the mobile publisher, including placing bids or paying a specific price set by the mobile publisher, to the mobile publisher for access to users. The mobile publisher will set rules for merchants to follow in order to place bids and may in some cases list conditions (or price) the merchant will have to fulfill to gain access to consumers. If a merchant is granted access to users by the mobile publisher, the merchant will be able to view information relating to consumers whose commerce behavior may be indicative of influencing sale of merchant products/service or be able to send selected digital content to these users for sharing with others in their network.

In deciding whether to grant merchants access, the mobile publisher may receive bids from merchants 503 and then decides which bid to select 504. The mobile publisher, as part of attracting merchants to the platform to bid, may guarantee use of merchant content by consumers of the mobile application or wallet. The guarantee may include the number of times the content will be shared, average money spent on a particular product/service, or the average time the content will be tagged, including the terms that consumers used while tagging content. In choosing which merchant bids to select, the mobile publisher may consider elements such as the price merchant is willing to pay for access to the consumer, amount of money the merchant has spent in serving ads to consumers of the wallet or application, number of times the merchant has served content to consumers, length of time merchant has requested access to consumer(s) (few hours vs. days a merchant can reach a set of users), and/or the time of serving content (day, evening, holiday season etc) within the mobile application or wallet. After the mobile publisher selects merchant bids, it fulfills merchant request(s) by serving content 505 to selected consumers (or clusters) of the mobile application or wallet. The mobile publisher tracks the performance of the content and sends reporting data back to the merchants 507. Data is also sent to the database 515 for storage to further refine and enrich the data relating to consumer activity with the mobile application or wallet. The performance data and updated scores are sent back to the dashboard 501 on the portal for use in updating the customer index, bidding platform, and other services hosted by the dashboard. The mobile commerce dashboard continually updates data as merchants continue to serve content and consumers engage with content served in the mobile wallet or application with the feedback loop 508.

The portal may also contain a campaign creator 509. Merchants can use the campaign creator 509 to create specialized digital campaigns, including advertisement, coupons, or special offers, that are relevant to consumer's needs. For example, merchants may send free coffee offers to those consumers who love coffee. For these consumers, merchants may require additional activities or tasks to be performed by the consumer (such as sharing the coffee offer or merchant's products, helping bring friends to a store, or completing a purchase of a certain product or amount using mobile app/wallet) for additional specialized rewards. In creating campaigns, merchants will have the ability to discriminate submission of digital content to specific consumers (or a cluster of consumers) based on their activity with the merchant content. The mobile publisher fulfills the request of merchants by sending specific campaigns 510 for the merchants to selected users or cluster of users 511. The campaigns may be sent to the user or cluster of users 511 as content served within the mobile application or wallet 505. The mobile publisher tracks performance of the specialized campaigns/content and sends reporting back to the merchant 507 for consumption. Data is also sent to the database 515 for storage to further refine and enrich the data relating to consumer activity with the mobile application or wallet. The performance data is also sent back to the merchant portal 512 and the dashboard 501 on the portal for use in updating the customer index, bidding platform, campaign creator and other services hosted by the dashboard. The mobile commerce dashboard continually updates data as merchants continue to serve content and consumers engage with content served in the mobile wallet or application as shown with the feedback loop 508 (servers 513, 514 and customer data 515). In certain embodiments a feedback loop may be created between the mobile wallet 505 and the dashboard 501.

1. A computer implemented method of enabling a user to interact with merchant content, the method comprising the steps of:
a. providing the merchant content that varies according to the user interaction within an application executed on a mobile communication device;
b. providing a user interface within the application;
c. providing selectable options on the merchant content allowing the user to tag the merchant content;
d. providing the selectable options within the application allowing the user to share the merchant content with others other users; and
e. tracking consumer interaction with the mobile content.

2. The computer implemented method of claim 1, wherein the merchant content includes digital content which is redeemed at a merchant location.

3. The computer implemented method of claim 1, wherein the selectable options for tagging the merchant content are provided as a predetermined list of terms.

4. The computer implemented method of claim 3, further comprising the step of:
dynamically changing terms in the predetermined list of terms based on the merchant content and tracked user activity with previously viewed merchant content.

5. The computer implemented method of claim 1, further comprising the step of:
delivering the merchant content directly to a merchant location when the user selects an option to share with the other users.

6. A computer-implemented method of providing an information portal on consumer user activity level related to merchant content provided in a mobile application, the method comprising the steps of:
a. providing an information portal accessible over a network connection or through a mobile application executed on a mobile device or accessible on a personal computer;
b. tracking and storing information relating to the user activity related to the merchant content within the mobile application, wherein the user may interact with or share the merchant content using the mobile application;
c. identifying an active and or an inactive user based on a level of interaction with the merchant content and a number of times each user shares the merchant content;
d. tracking the merchant content the user chooses to interact with, the merchant content the user chooses to share, and the frequency that the user interacts with and shares merchant content; and
e. generating a customer index relating to a level of interaction of the user with the merchant content.

7. The computer implemented method of claim 6, further comprising the step of:
providing a bidding platform within the information portal, wherein the bidding platform accepts merchant bids for access to selected users.

8. The computer implemented method of claim 6, further comprising the step of:
generating a score level for each the user based on the level of interaction the user has with the merchant content served in the mobile application.

9. The computer implemented method of claim 6, further comprising the step of:
modulating the merchant content served in the mobile application,
wherein the step of modulating the merchant content removes an inactive user.

10. A system for of enabling a user to interact with merchant content, comprising:
a. providing the merchant content to the user such that the merchant content varies according to the user interaction within an application executed on a mobile communication device;
b. providing a user interface within the application;
c. providing selectable options on the merchant content allowing the user to tag the merchant content;
d. providing the selectable options within the application allowing the user to share the merchant content with other users; and
e. tracking consumer interaction with the mobile content.

11. The system of claim 10, wherein the merchant content includes digital content which is redeemed at a merchant location.

12. The system of claim 10, wherein the selectable options for tagging the merchant content are provided as a predetermined list of terms.

13. The system of claim 12, further comprising:
dynamically changing terms in the predetermined list of terms based on the merchant content and tracked user activity with previously viewed merchant content.

14. The system of claim 10, further comprising:
delivering the merchant content directly to a merchant location when the user selects an option to share with the other users.
